(19) United States
(12) Patent Application Publication
(10) Pub. No.: US 2015/0358512 A1
(43) Pub. Date: Dec. 10, 2015

(54) OPENING-CLOSING DEVICE

(71) Applicant: MITSUBISHI STEEL MFG. CO., LTD., Tokyo (JP)

(72) Inventor: Yasuhiro MITSUI, Chiba (JP)

(21) Appl. No.: 14/760,749

(22) PCT Filed: Jan. 10, 2014
(86) PCT No.: PCT/JP2014/050352

§ 371 Date: Jul. 14, 2015

(30) Foreign Application Priority Data
Jan. 16, 2013 (JP) 2013-005633

(51) Int. Cl. H04N 5/225; H04N 5/232; E05D 15/58

(52) U.S. Cl. CPC H04N 5/2252; E05D 15/58; H04N 5/23293; E05D 2015/585

(57) ABSTRACT

An opening-closing device includes a main plate fixed to a first housing, an arm plate fixed to a second housing, a hinge mechanism that couples the arm plate to the main plate such that the arm plate is rotatable between a closed position and an open position, a slide plate slidably attached to the arm plate, and a biasing part that biases the slide plate. When the arm plate is opened or closed with respect to the main plate, the biasing part biases the slide plate so that the second housing contacts the first housing, and the slide plate slides relative to the arm plate according to a state of contact between the first housing and the second housing.

### TECHNICAL FIELD

An aspect of this disclosure relates to an opening-closing device.

### BACKGROUND ART

There exists an electronic apparatus such as a digital camera, a video camera, or a cellphone that includes a built-in liquid crystal display for viewing a captured image. There also exists an electronic apparatus where a display unit is configured to be movable relative to a body of the electronic apparatus to allow a user to view a liquid crystal display from various angles.

This type of an electronic apparatus is configured to store the display unit in a back side of the body in a normal mode such the liquid crystal display of the stored display unit is viewable. Here, depending on a shooting condition such as a shooting position, the liquid crystal display may become not viewable with the display unit stored in the body. In this case, the display unit is moved relative to the body to make the liquid crystal display viewable even in such a shooting condition.

In recent years, it has become common to use an electronic apparatus such as a digital camera to take a picture of oneself (i.e., selfie). In such a case, with the display unit stored in the back side of the body, a user positioned in front of the body cannot view the liquid crystal display. For this reason, there has been provided an electronic apparatus configured such that a display unit is movable to a position where even a user positioned in front of the body of the electronic apparatus can view a liquid crystal display (see Patent Document 1).

### RELATED-ART DOCUMENT

### Patent Document

Patent document 1: Japanese Laid-Open Patent Publication No. 2006-138959

### DISCLOSURE OF INVENTION

### Problems to be Solved by the Invention

However, because a display unit including a liquid crystal display has a relatively large thickness, with a configuration where a display unit is simply rotated relative to a body of an electronic apparatus around a rotational axis, corners of the display unit and the body close to the rotational axis contact each other during the rotation, and it becomes difficult to smoothly rotate the display unit.

Here, when an electronic apparatus includes an opening-closing mechanism, it is desired to make a hinge connecting a display unit and a body invisible from the outside to improve the design of the electronic apparatus. In this case, the above problem is particularly important.

To prevent a display unit and a body from contacting each other, it may be possible to use a parallel biaxial hinge between the display unit and the body as disclosed in Patent Document 1. With a configuration using a biaxial hinge, however, the movement of the display unit becomes unstable due to two rotational axes, and the operability of the display unit is reduced because an operation to open or close the display unit involves two actions.

The present invention is made taking into account the above problems. One object of the present invention is to provide an opening-closing device with improved operability.

### Means for Solving the Problems

In an aspect of this disclosure, there is provided an opening-closing device that includes a main plate fixed to a first housing, an arm plate fixed to a second housing, a hinge mechanism that couples the arm plate to the main plate such that the arm plate is rotatable between a closed position and an open position, a slide plate slidably attached to the arm plate, and a biasing part that biases the slide plate. When the arm plate is opened or closed with respect to the main plate, the biasing part biases the slide plate so that the second housing contacts the first housing, and the slide plate slides relative to the arm plate according to a state of contact between the first housing and the second housing.

### Advantageous Effect of the Invention

A disclosed opening-closing device makes it possible to open or close an arm plate by a single action and thereby makes it possible to improve operability.

### BRIEF DESCRIPTION OF THE DRAWINGS

FIG. 1 is an exploded perspective view of an opening-closing device according to an embodiment of the present invention;

FIG. 2A is a perspective view of an opening-closing device in a closed state according to an embodiment of the present invention;

FIG. 2B is a perspective view of an electronic apparatus that is in a closed state and includes an opening-closing device according to an embodiment of the present invention;

FIG. 3A is a perspective view of an opening-closing device in an open state according to an embodiment of the present invention;

FIG. 3B is a perspective view of an electronic apparatus that is in an open state and includes an opening-closing device according to an embodiment of the present invention;

FIG. 4A is a drawing used to describe an operation of an opening-closing device according to an embodiment of the present invention;

FIG. 4B is a drawing used to describe an operation of an opening-closing device according to an embodiment of the present invention;

FIG. 4C is a drawing used to describe an operation of an opening-closing device according to an embodiment of the present invention;

FIG. 4D is a drawing used to describe an operation of an opening-closing device according to an embodiment of the present invention;

FIG. 4E is a drawing used to describe an operation of an opening-closing device according to an embodiment of the present invention;

FIG. 4F is a drawing used to describe an operation of an opening-closing device according to an embodiment of the present invention; and

FIG. 5 is a perspective view of an opening-closing device according to a variation of an embodiment of the present invention.

### DESCRIPTION OF EMBODIMENTS

Embodiments of the present invention are described below with reference to the accompanying drawings.

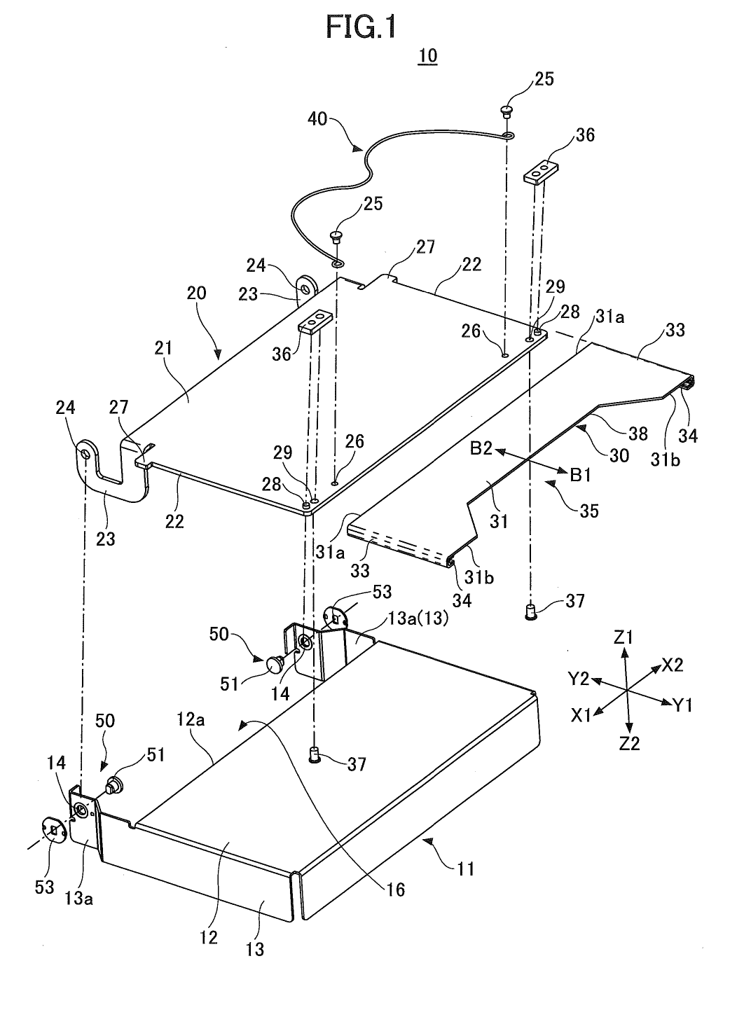

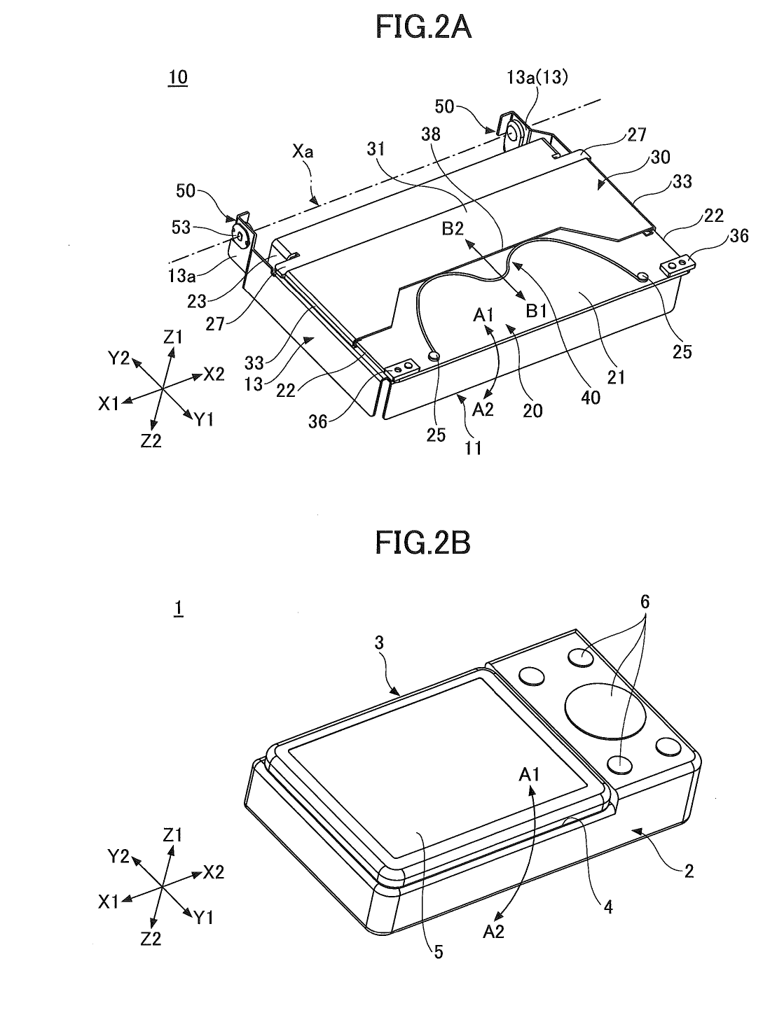

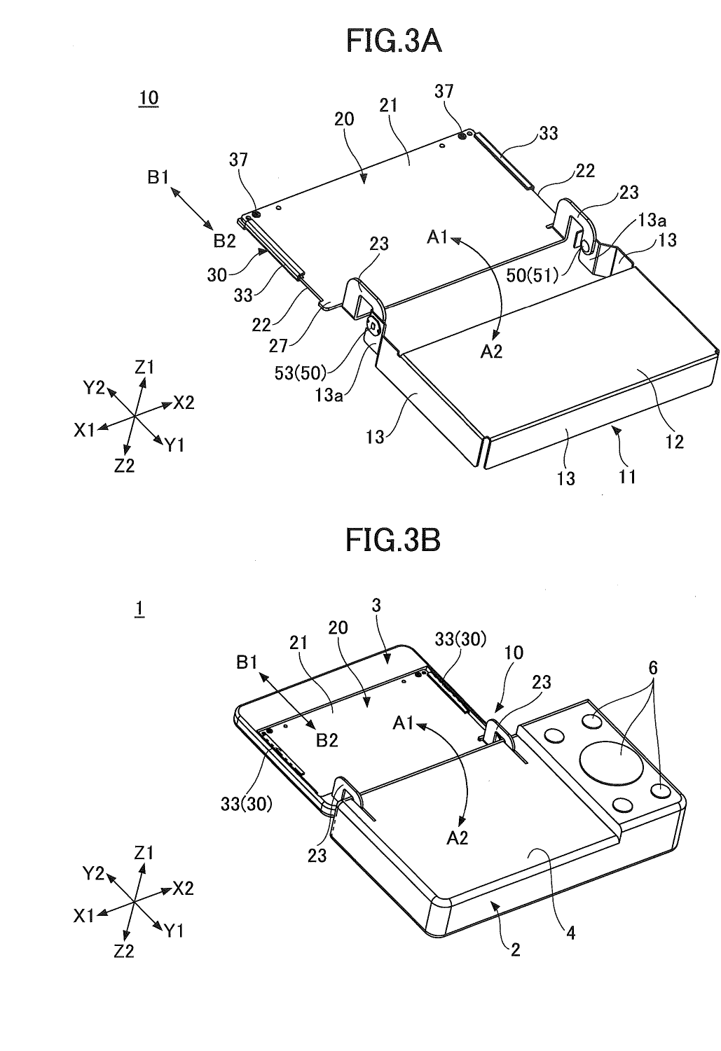

FIGS. 1 through 3B are drawings illustrating an opening-closing device 10 according to an embodiment of the present invention. FIG. 1 is an exploded perspective view of the opening-closing device 10, FIG. 2A is a perspective view of the opening-closing device 10 in a closed state where an arm plate 20 is closed with respect to a main plate 11, FIG. 2B is a perspective view of an electronic apparatus 1 including the opening-closing device 10 in the closed state, FIG. 3A is a perspective view of the opening-closing device 10 in an open state where the arm plate 20 is open with respect to the main plate 11, and FIG. 3B is a perspective view of the electronic apparatus 1 including the opening-closing device 10 in the open state.

The opening-closing device 10 of the present embodiment is provided in the electronic apparatus 1 as illustrated by FIG. 2B and FIG. 3B, and has a function to enable a display unit 3 to be opened and closed with respect to a body 2.

Before describing the opening-closing device 10, the electronic apparatus 1 including the opening-closing device 10 is described. In the present embodiment, it is assumed that the electronic apparatus 1 is a digital camera. However, the present invention may be applied not only to a digital camera, but also to any other type of electronic apparatus such as a video camera or a cellphone including a movable part 3 that rotates relative to the body 2.

The electronic apparatus 1 includes the body 2 (first housing) and a display unit 3 (second housing). FIGS. 2B and 3B illustrate a back side of the electronic apparatus 1. The display unit 3 and switches 6 are provided on the back side. An imaging lens (not shown) for capturing an image is provided on a front side of the electronic apparatus 1.

The display unit 3 includes a liquid crystal display 5. An image captured via the imaging lens is displayed on the liquid crystal display 5. A user can view an image to be captured on the liquid crystal display 5.

When taking a picture in a normal way, the display unit 3 is stored in a display unit holder 4 as illustrated by FIG. 2B, and the display unit 3 and the body 2 are combined together. In the descriptions below, a state where the display unit 3 of the electronic apparatus 1 and the opening-closing device 10 are stored in the display unit holder 4 is referred to as a “closed state”.

As described above, it has become common to use an electronic apparatus to take a picture of oneself (i.e., selfie). The electronic apparatus 1 and the opening-closing device 10 have configurations suitable for this purpose. For example, with the opening-closing device 10, the display unit 3 is configured to be movable (or rotatable) relative to the body 2 in A1 and A2 directions indicated in the figures.

FIG. 3B illustrates a state where the display unit 3 is open with respect to the body 2. In the descriptions below, a state where the display unit 3 is open with respect to the body 2 of the electronic apparatus 1 and the opening-closing device 10 is referred to as an “open state”.

In the open state, both of the imaging lens and the liquid crystal display 5 are on the front side of the body 2 (i.e., facing forward). With this configuration, a user can take a picture of oneself while viewing one's own image on the liquid crystal display 5.

Next, a configuration of the opening-closing device 10 is described mainly using FIG. 1. The opening-closing device 10 includes a main plate 11, an arm plate 20, a sliding plate 30, a wire spring 40, and a hinge mechanism 50.

The main plate 11 is formed by pressing a single metal plate into a case shape including a main plate body 12 and side plates 13. The main plate 11 is fixed to the body 2 using, for example, fixing screws (not shown).

The main plate body 12 has a substantially rectangular shape, three sides of which are bent downward to form the side plates 13. Among the three side plates 13, two side plates 13 located at the short sides of the arm plate body 21 extend from the arm plate body 21 in a Y2 direction in FIG. 1 and form extensions 13a.

A shaft hole 14, into which a hinge pin 51 is to be inserted, is formed in each of the extensions 13a. A space 16 is formed between the extensions 13a that are apart from each other in X1 and X2 directions in FIG. 1. The space 16 provides room for arms 23 described below to rotate.

The arm plate 20 is formed by pressing a single metal plate, and includes an arm plate body 21, guide rails 22, and arms 23. The arm plate body 21 has a substantially rectangular shape whose short sides function as the guide rails 22.

The arms 23 are formed at the ends of the Y2 side of the arm plate body 21. Each arm 23 has a substantially square-bracket shape in side view. One end of the arm 23 is seamlessly joined with the arm plate body 21, and a shaft hole 24, into which the hinge pin 51 is to be inserted, is formed in another end of the arm 23.

Also, stoppers 36 are provided on the arm plate body 21. The stoppers 36 are disposed at the ends of the Y1 side of the arm plate body 21.

Each stopper 36 includes a pair of holes, and one of the holes is fitted onto a protrusion 28 formed on the arm plate body 21. Also, a fixing pin 37 (which may be replaced with, for example, a screw) is fitted via an insertion hole 29 formed in the arm plate body 21 into the other one of the holes. Thus, the stopper 36 is fixed to the arm plate 20.

Also, the wire spring 40 (biasing part) is provided substantially in the middle of the arm plate body 21. The wire spring 40 has a substantially M-shape in plan view (see FIG. 2A). Ends of the wire spring 40 are fixed to the arm plate body 21 (arm plate 20) by fitting spring pins 25 into pin holes 26.

As described later, the wire spring 40, with its elastic force, biases the slide plate 30 with respect to the arm plate 20. Although the wire spring 40 is used as a biasing part in the present embodiment, any other type of biasing part may also be used. Examples of such biasing parts include a torsion spring, a composite spring, and a spring unit composed of multiple small coils.

The slide plate 30 is formed by pressing a metal plate, and includes a slide plate body 31 and slide guides 33. The slide plate 30 slides on the arm plate 20 in the Y1 and Y2 directions in FIG. 1.

The slide plate body 31 is long in the X1 and X2 directions. A recess 35 having a trapezoidal shape is formed on the Y1 side. An edge of the recess 35 of the slide plate body 31 functions as an engaging part 38 that engages with the wire spring 40 (see FIG. 2A).

The slide guides 33 are formed at the ends (X1 and X2 ends) of the slide plate body 31. The slide guides 33 are formed by bending the ends of the slide plate body 31. A square-bracket shaped groove 34 is formed in each slide guide 33. Resin guides (not shown) are provided in the square-bracket shaped grooves 34 to improve slidability.

The guide rails 22 of the arm plate 20 are inserted into the square-bracket shaped grooves 34. The guide rails 22 are movably supported by the resin guides disposed in the square-bracket shaped grooves 34. With this configuration, the slide plate 30 can smoothly and stably slide in the Y1 and Y2 directions relative to the arm plate 20.

Ends of the Y2 side of the slide plate body 31 function as first contact parts 31a that contact stoppers 27 formed in the arm plate 20 when the slide plate 30 slides. Also, ends of the Y1 side of the slide plate body 31 (i.e., parts on the sides of the recess 34) function as second contact parts 31b that contact the stoppers 36 provided on the arm plate 20. Thus, the slide plate 30 is slidable between a position where the first contact parts 31a contact the stoppers 27 and a position where the second contact parts 31b contact the stoppers 36.

The hinge mechanism 50 rotatably connects the main plate 11 and the arm plate 20. The hinge mechanism 50 includes hinge pins 51 and click plates 53.

Next, a method of assembling the opening-closing device 10 is described.

The method of assembling the opening-closing device 10 includes a step of attaching the arm plate 20 to the main plate 11, and a step of attaching the slide plate 30 to the arm plate 20. These steps may be performed in any order, or may be performed concurrently. In the exemplary method described below, the slide plate 30 is attached to the arm plate 20, and then the arm plate 20 is attached to the main plate 11.

In assembling the opening-closing device 10, the resin guides are first fixed in the square-bracket shaped grooves 34. To fix the resin guides, for example, the resin guides may be fit into the slide plate 30 or may be formed by insert molding in the slide plate 30.

After the resin guides are fixed in the square-bracket shaped grooves 34, the slide plate 30 is attached to the arm plate 20. More specifically, the resin guides in the square-bracket shaped grooves 34 and the guide rails 22 are aligned with each other, and then the guide rails 22 are inserted into the square-bracket shaped grooves 34 (or the resin guides). Thus, the guide rails 22 and the slide guides 33 slidably engage with each other.

Next, the stoppers 36 are fixed to the arm plate 20 with the fixing pins 37. Thus, the slide plate 30 becomes slidable between a position where the first contact parts 31a contact the stoppers 27 and a position where the second contact parts 31b contact the stoppers 36. This configuration makes it possible to prevent the slide plate 30 coming away from the arm plate 20.

Next, the wire spring 40 is fixed to the arm plate 20 with the spring pins 25 such that the wire spring 40 engages with the engaging part 38 of the slide plate 30. Accordingly, the slide plate 30 is biased in the Y2 direction by the elastic force of the wire spring 40. Still, however, because the first contact parts 31a contact the stoppers 27, the slide plate 30 is prevented from sliding further.

After the slide plate 30 is attached to the arm plate 20 as described above, the slide plate 30 is attached to the main plate 11.

In attaching the slide plate 30 to the main plate 11, the shaft holes 24 formed in the arms 23 of the arm plate 20 are aligned with the shaft holes 14 formed in the extensions 13a of the main plate 11. After the alignment, the hinge pins 51 of the hinge mechanism 50 are inserted into the shaft holes 14 and the shaft holes 24 from the inside toward the outside. Then, the click plates 53 are fixed to the ends of the hinge pins 51 protruding outward from the shaft holes 14.

Thus, the arm plate 20 and the slide plate 30 attached to the arm plate 20 are rotatably coupled to the main plate 11 by the hinge mechanism 50. The hinge mechanism 50 is a free-stop hinge that can hold the arm plate 20 at any rotational angle relative to the main plate 11. However, the hinge mechanism 50 is not necessarily a free-stop hinge. For example, grooves may be formed in the main plate 11 so that the hinge mechanism 50 clicks at open and closed positions and at predetermined angles between the open and closed positions.

The opening-closing device 10 is assembled through a process as described above. In the assembled opening-closing device 10, as illustrated by FIG. 2A, the slide plate 30 is biased by the wire spring 40 and moved to a position where it contacts the arm 23, and the arm plate 20 is configured to be movable in the A1 and A2 directions around the hinge mechanism 50 relative to the main plate 11.

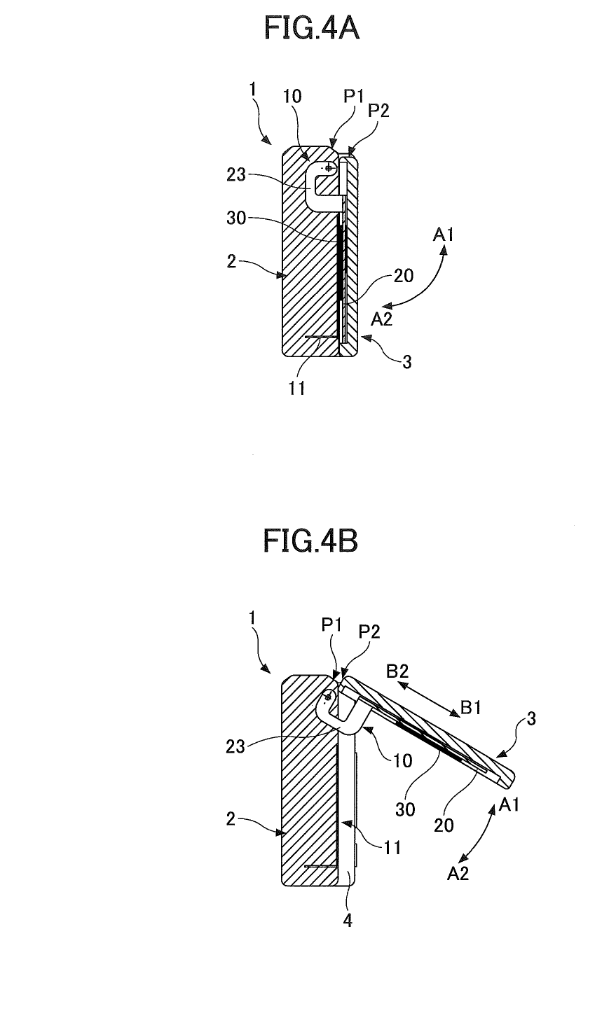

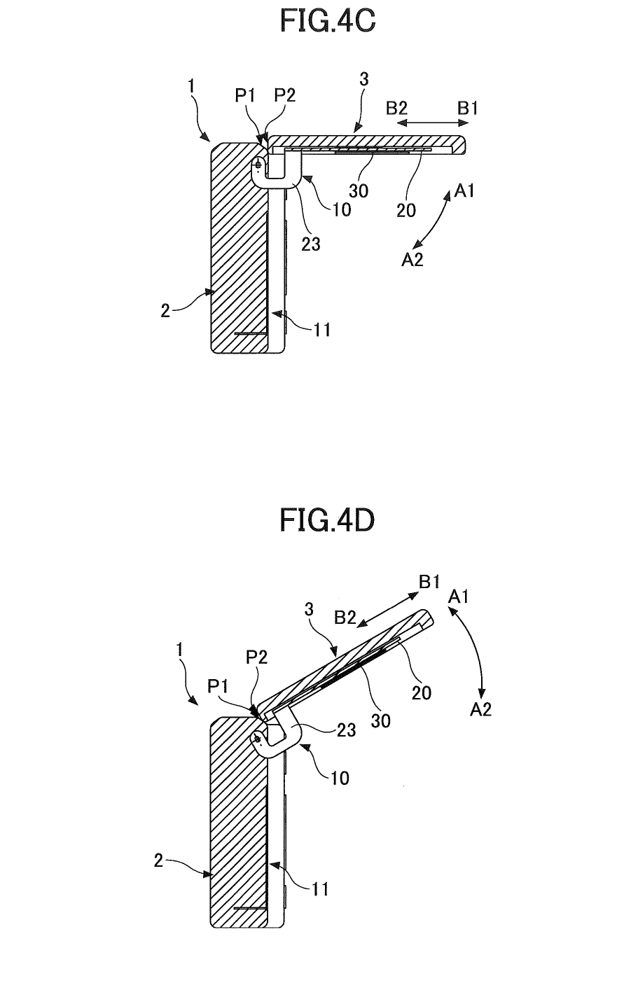

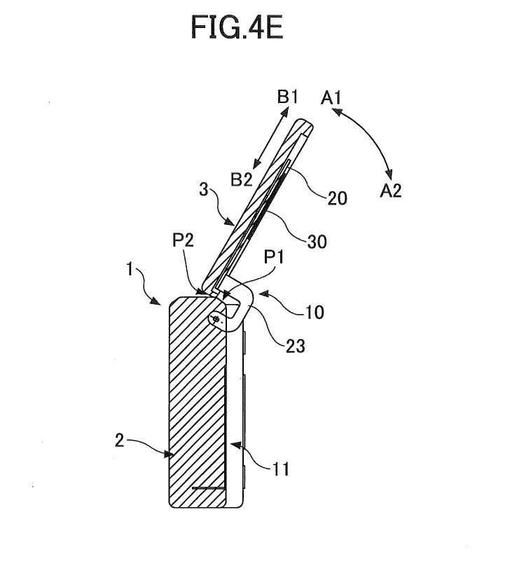

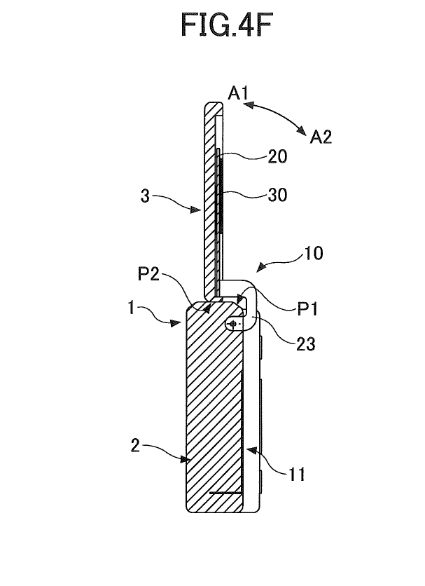

Next, operations of the opening-closing device 10 configured as described above are described with reference to FIGS. 2A through 3B and FIGS. 4A through 4F. FIGS. 4A through 4F are side views illustrating an operation of the opening-closing device 10 in sequence.

Below, an opening operation to change the opening-closing device 10 from a closed state to an open state is described. FIGS. 2A, 2B, and 4A illustrate a closed state where the arm plate 20 is closed with respect to the main plate 11. The arm plate 20 and the slide plate 30 attached to the arm plate 20 are rotated in the A2 direction to be placed in the closed state. In the closed state, the plates 11, 20, and 30 substantially overlap each other in side view. In the descriptions below, the position of the arm plate 20 in the closed state is referred to as a “closed position”.

Also in the closed state, the slide plate 30 is caused to slide in a B2 direction in the figures by the elastic force of the wire spring 40, and the sliding movement of the slide plate 30 is limited by contact between the first contact parts 31a and the stoppers 27. In the descriptions below, the position of the slide plate 30 in the closed state is referred to as a “first position”.

FIG. 2B illustrates the electronic apparatus 1 in the closed state. In the closed state, the display unit 3 is stored in the display unit holder 4 formed in the body 2. The Y1-Y2 dimension of the display unit 3 is substantially the same as the Y1-Y2 dimension of the body 2. This configuration makes it possible to increase the size of the display unit 3, and to use a large liquid crystal display 5. Also, in the state where the display unit 3 is stored in the body 2, no step or gap is formed between the body 2 and the display unit 3. This configuration makes it possible to improve the design of the electronic apparatus 1.

In FIG. 4A, an arrow P2 indicates a corner of the display unit 3 (display unit corner P2), and an arrow P1 indicates a corner of the body 2 (body corner P1). In the closed state, the corners P1 and P2 are positioned close to each other.

To change the electronic apparatus 1 including the opening-closing device 10 from the closed state to the open state, the display unit 3 is rotated in the A1 direction relative to the body 2. As a result, the arm plate 20 fixed to the display unit 3 rotates in the A1 direction relative to the main plate 11 fixed to the body 2.

When the arm plate 20 rotates about 5 degrees in the A1 direction from the closed state, the body corner P1 and the display unit corner P2 contact each other. Thereafter, the display unit 3 (the arm plate 20) rotates with the corners P1 and P2 kept in contact with each other.

When the opening operation of the display unit 3 (the arm plate 20) is continued, the display unit 3 (the arm plate 20) gradually opens with respect to the body 2 (the main plate 11) as illustrated by FIGS. 4B through 4E. During this operation, the body corner P1 and the display corner P2 are kept in contact with each other.

Here, assume a configuration where the slide plate 30 is not provided and the display unit 3 is directly fixed to the arm plate 20 (i.e., a configuration where the display unit 3 is not movable relative to the arm plate 20). With such a configuration, after the body corner P1 and the display unit corner P2 are brought into contact with each other, it is not possible to rotate the display unit 3 (the arm plate 20) further.

On the other hand, the opening-closing device 10 of the present embodiment is configured such that the slide plate 30, to which the display unit 3 is attached, is slidable relative to the arm plate 20. Also in the present embodiment, the slide plate 30 (the display unit 3) is biased by the wire spring 40 to move in the B2 direction (or toward a position where the hinge mechanism 50 is provided).

With this configuration, when the display unit 3 (the arm plate 20) rotates in the A1 direction and the display unit corner P2 contacts the body corner P1, the slide plate 30 moves in a B1 direction in the figures (i.e., a direction away from the hinge mechanism 50) relative to the arm plate 20 against the elastic force of the wire spring 40. Accordingly, the display unit 3 fixed to the slide plate 30 also moves in the B1 direction.

Because the display unit 3 moves in such a direction that the display corner P2 moves away from the body corner P1, the display unit 3 (the arm plate 20, the slide plate 30) can be further rotated relative to the body 2 (the main plate 11).

Also, while being rotated, the display unit 3 is biased by the elastic force (spring force) of the wire spring 40 in the B2 direction. Therefore, while the display unit 3 rotates relative to the body 2, the display unit corner P2 is pressed by the elastic force of the wire spring 40 against the body corner P1.

Here, the body corner P1 and the display unit corner P2, at which the body 2 and the display unit 3 contact each other, are formed to have curved surfaces with predetermined curvature. With this configuration, the display unit corner P2 is substantially in line contact with the body corner P1 while the display unit 3 is rotated, and therefore excessive abrasion of and excessive friction between the corners P1 and P2 can be prevented even when the display unit corner P2 is pressed by the wire spring 40 against the body corner P1.

FIGS. 3A, 3B, and 4F illustrate an open state where the display unit 3 (the arm plate 20) is rotated 180 degrees relative to the body 2 (the main plate 11) (the position of the arm plate 20 in the open state is referred to as an “open position”).

In the opening-closing device 10 of the present embodiment, when the display unit 3 is rotated about 180 degrees from the closed position, the amount of movement of the slide plate 30 in the B1 direction becomes largest (the position of the slide plate 30 in this state is referred to as a “second position”).

In the open state, the liquid crystal display 5 of the display unit 3 faces forward (in the figures, a Z2 direction), enabling a user to take a picture of oneself. Also in the open state, because the display unit corner P2 is pressed by the elastic force of the wire spring 40 against the body 2, the display unit 3 is stable and does not rattle.

A closing operation to close the display unit 3 in the open state (or the arm plate 20 in the open position) is opposite of the opening operation to open the display unit 3 described above, and therefore descriptions of the closing operation are omitted here.

As described above, the opening-closing device 10 of the present embodiment is configured such that a change in the distance between the body corner P1 and the display unit corner P2 during the rotation of the arm plate 20 from the closed position to the open position is reduced by allowing the display unit 3 (the slide plate 30) to move relative to the arm plate 20 according to the state of contact between the body corner P1 and the display unit corner P2. This configuration makes it possible to prevent the display unit 3 from becoming unable to smoothly rotate as in the related art when the body corner P1 and the display unit corner P2 contact each other, and makes it possible to smoothly open the display unit 3 from the closed state to the open state.

Also with the opening-closing device 10 of the present embodiment, the arm plate 20 can be opened or closed between the closed position and the open position by a single action, i.e., by simply rotating the display unit 3 fixed to the arm plate 20. Thus, with the electronic apparatus 1 including the opening-closing device 10, the display unit 3 can be opened and closed smoothly and easily.

The opening-closing device 10 of the present embodiment is also configured such that the arm plate 20 rotates relative to the main plate 11 around one pair of hinge pins 51. Compared with, for example, a configuration using a parallel biaxial hinge, the configuration of the present embodiment makes it possible to perform an opening/closing operation by a single action and improve operability, and makes it possible to stably rotate the display unit 3 and the arm plate 20.

Further in the present embodiment, the arms 23 are formed to have a substantially square-bracket shape in side view so that the hinge mechanism 50 can be disposed inside of the body 2. Compared with a configuration where a hinge mechanism protrudes from a body of an apparatus, the configuration of the present embodiment makes it possible to improve the design of the electronic apparatus 1.

The “body corner P1” in the above descriptions does not refer to only a corner of the body 2, but refers to an area of the body 2 that contacts the display unit corner P2 when the display unit 3 is rotated.

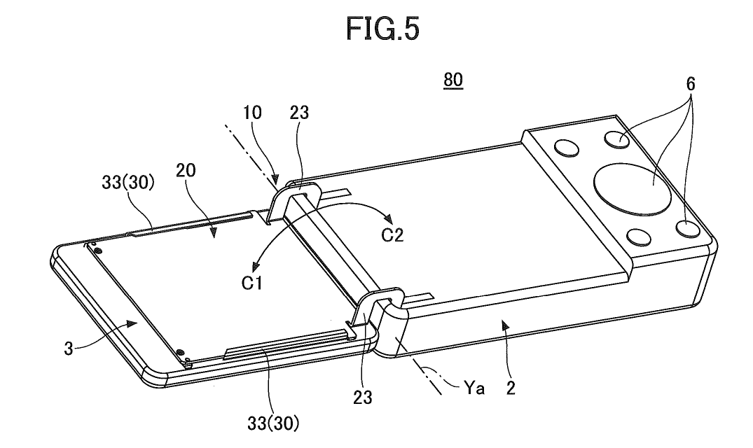

FIG. 5 illustrates an opening-closing device 80 that is a variation of the opening-closing device 10 of the above embodiment. The same reference numbers assigned to components in FIGS. 1 through 4F are assigned to the corresponding components in FIG. 5, and descriptions of those components are omitted here.

The opening-closing device 10 of the above embodiment is configured such that the display unit 3 is rotated relative to the body 2 around a rotational axis Xₐ (see FIG. 2A) that is parallel to the X1 and X2 directions.

On the other hand, the opening-closing device 80 of this variation is configured such that the display unit 3 is rotated relative to the body 2 around a rotational axis Yₐ (see FIG. 5) that is parallel to the Y1 and Y2 directions. The configuration of this variation, where the display unit 3 is opened in a lateral direction relative to the body 2, also provides advantageous effects similar to those provided by the above embodiment.

Preferred embodiments of the present invention are described above. However, the present invention is not limited to the specifically disclosed embodiments, and variations and modifications may be made without departing from the scope of the present invention.

For example, instead of disposing the wire spring 40 on the arm plate 20, the wire spring 40 may be disposed on the slide plate 30.

The present application claims priority from Japanese Patent Application No. 2013-005633 filed on Jan. 16, 2013, the entire contents of which are hereby incorporated herein by reference.

### EXPLANATION OF REFERENCE NUMERALS

1, 80 Electronic apparatus

2 Body

3 Display unit

4 Display unit holder

5 Liquid crystal display

10 Opening-closing device

11 Main plate

12 Main plate body

13 Side plate

14 Shaft hole

20 Arm plate

21 Arm plate body

22 Guide rail

23 Arm

24 Shaft hole

25 Spring pin

27 Stopper

30 Slide plate

31 Slide plate body

33 Slide guide

34 Square-bracket shaped groove

36 Stopper

38 Engaging part

40 Wire spring

50 Hinge mechanism

51 Hinge pin

1. An opening-closing device, comprising:
a main plate fixed to a first housing;
an arm plate fixed to a second housing;
a hinge mechanism that couples the arm plate to the main plate such that the arm plate is rotatable between a closed position and an open position;
a slide plate slidably attached to the arm plate; and
a biasing part that biases the slide plate,
wherein the opening-closing device is configured such that when the arm plate is opened or closed with respect to the main plate,
the biasing part biases the slide plate so that the second housing contacts the first housing, and
the slide plate slides relative to the arm plate according to a state of contact between the first housing and the second housing.

2. The opening-closing device as claimed in claim 1, wherein the hinge mechanism is disposed in the first housing.

3. The opening-closing device as claimed in claim 1, wherein the biasing part is a wire spring.

4. The opening-closing device as claimed in claim 1, wherein
the first housing is a body of a camera; and
the second housing is a movable part where a liquid crystal display monitor of the camera is disposed.
